(19) United States
(12) Patent Application Publication
(10) Pub. No.: US 2004/0136179 A1
(43) Pub. Date: Jul. 15, 2004

(54) Necklace with ultraviolet illuminated fluorescent pendant

(76) Inventors: Edward D. Lewis, Brownsburg, IN (US); Daniel J. Deutsch, Orlando, FL (US)

Correspondence Address: BAHRET & ASSOCIATES, 320 NORTH MERIDIAN STREET, SUITE 512, INDIANAPOLIS, IN, 46204, US

(21) Appl. No.: 10/341,322

(22) Filed: Jan. 13, 2003

(51) Int. Cl. F21V 21/08

(52) U.S. Cl. 362/104

(57) ABSTRACT

A necklace with a pendant having fluorescent pigment illuminated by a UV LED. The necklace includes an electrical power source such as a button cell and an electrical switch for selectively controlling the flow of electrical current between the power source and the LED. The fluorescent pigment of the pendant emits visible light in response to being illuminated by ultraviolet light.

### BACKGROUND OF THE INVENTION

This invention relates to necklaces, jewelry, pendants and the like worn in a loop around the neck of the wearer, and particularly to necklaces having a self-contained power source and source of illumination for a pendant.

It is known to provide a necklace with a self-contained power source and a source of illumination to light a pendant. See, for example, U.S. Pat. No. 6,233,971 Ohlund. Necklaces with illuminated pendants can include a lamp of the light-emitting diode (LED) or incandescent type, a battery, and an electrical switch and circuit to control the flow of current between the battery and the lamp, with conductors being located within the strand of the necklace.

### SUMMARY OF THE INVENTION

The present invention provides a necklace including an illuminated pendant having fluorescent pigment illuminated by an ultraviolet (UV) LED. An electrical switch selectively controls the flow of electrical current between an electrical power source and the UV LED.

Other aspects of the present invention will be apparent from the following description of preferred embodiments with reference to the accompanying drawings.

### BRIEF DESCRIPTION OF THE DRAWINGS

FIG. 1 is a front view of one embodiment of a necklace with an ultraviolet illuminated pendant according to the present invention.

FIG. 2 is a cross-sectional view of the battery housing of FIG. 1.

FIG. 3 is a front view, partially in section, of another embodiment of a necklace with an ultraviolet illuminated pendant according to the present invention.

### DETAILED DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device and such further applications of the principles of the invention as illustrated therein being contemplated as would normally occur to one skilled in the art to which the invention relates.

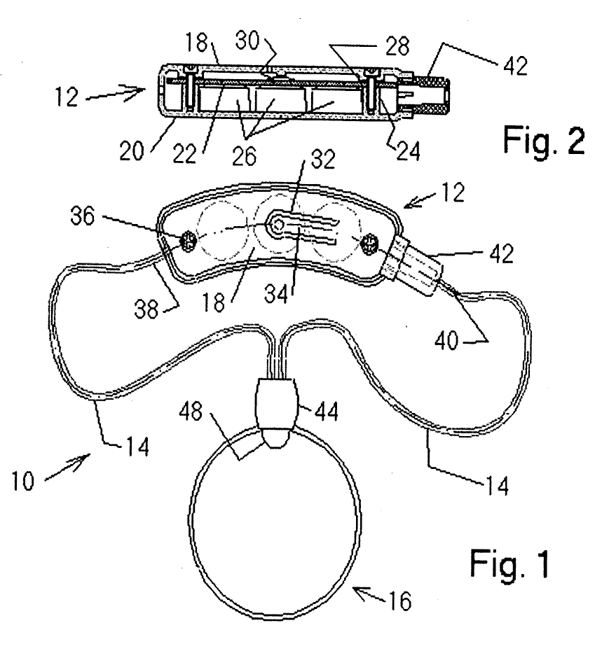

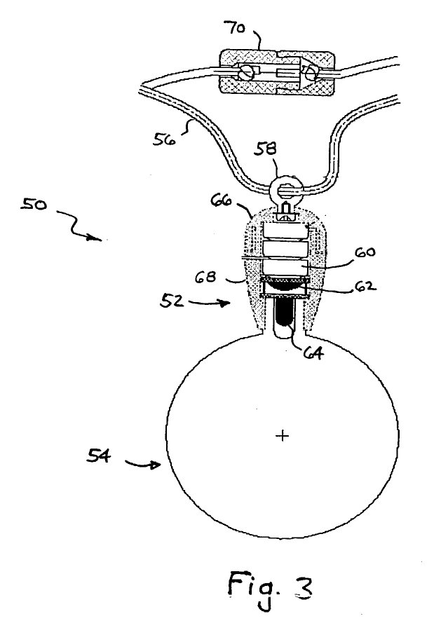

Referring to FIGS. 1-2, one embodiment of the present invention is a necklace 10 that includes a behind-the-neck battery housing 12, a necklace strand 14, and a pendant 16. Battery housing 12 includes a top shell 18 and a bottom shell 20 shaped and sized to contain a plurality of AG3 or other suitable button cells 26 and a printed circuit (pc) board 22, the pc board being supported by means of standoffs 24 and 28. The pendant may be illuminated by a flasher which may include an integrated circuit (IC), e.g., an AP3761-03 IC from Advanced Microelectronic Products, Inc., Taiwan, surface mounted on the pc board and configured to be triggered by a switch 30 which may be a metal dome pushbutton switch. A U-shaped through-slot 32 in top shell 18 defines a cantilevered switch actuator 34 that can be depressed elastically by the wearer to contact and actuate switch 30. A pair of screws 36 secure the top shell and bottom shell together, with the pc board sandwiched between, and with the button cells held in place between the pc board and the bottom shell.

Strand 14 of necklace 10 is preferably a cord having an electrical conductor therein and is mechanically secured at one end 38 to battery housing 12. The opposite end 40 of strand 14 is mechanically secured and electrically connected to an electrical connector 42 that is removably inserted into the battery housing. Connector 42 serves as a clasp to close the loop of the necklace and also serves to complete a circuit for illumination of the pendant as will be described.

Pendant 16 is mechanically connected to strand 14 by a barrel connector 44 which houses an ultraviolet (UV) LED 48 that extends partially into and edge-lights the pendant. Each lead of the UV LED connects to the electrical conductor of a respective branch of strand 14 and thereby to the flasher circuit within battery housing 12 when the clasp is closed. The circuit may be configured such that, once the IC is triggered by actuation of the momentary switch, the LED flashes in one-shot mode, i.e., for a predetermined period of time. Alternatively, the circuit may be configured to provide simple on-off operation of the LED.

Pendant 16 may be disc-shaped or may be made in other shapes, and is preferably formed of injection molded plastic material that is translucent or transparent. It is illuminated by UV LED 48 such that ultraviolet light entering the edge of the pendant is transmitted and guided throughout the plastic material of the pendant. The plastic material of the pendant 46 preferably has fluorescent pigment mixed therein prior to molding. In an alternative configuration that may be desirable for some applications, fluorescent pigment may be applied as a coating to the pendant surface. The ultraviolet light excites the fluorescent pigment and causes the pendant 46 to glow, creating a novel and pleasing aesthetic effect, and also back-lighting any indicia, design or graphics that may be provided on the pendant.

UV LED 48 emits light having a wavelength in the range of about 390 to about 410 nm, more preferably having a peak of about 390 nm to about 410 nm, and most preferably having a peak of about 400 nm. A suitable UV LED is the DL50PLDW503 UV LED available from Shue Kwong Optic Electronic Company, Shenzhen, China. The plastic material of pendant 16 may be a polycarbonate material that is mixed with fluorescent pigment and injection molded into a planar sheet or other desired shape. Alternatively, the plastic material may be polystyrene, PVC, ABS or acrylic materials. The pigment may be mixed at a ratio of about 1 to 2 grams of pigment per kilogram of plastic material. The fluorescent pigment may be a pigment that is commercially available from Wen Lee Plastic Pigment Company, Tungguong, China, such as Part No. 61113 (green), Part No. 31461 (blue), Part No. 238 (red). or Part No, 2600 (yellow).

FIG. 3 shows an embodiment of an illuminated necklace 50 according to the present invention in which a complete flasher circuit is contained within an oval-shaped housing 52 proximate the pendant 54 and held on a nonconductive necklace strand 56 by a swivel 58. The circuit includes a stacked arrangement of three button cells 60, an IC 62 and a UV LED 64 as shown in the drawing. The LED and the remainder of the circuit components may be the same as described above, except that in this embodiment the flasher circuit is actuated by simply twisting threaded parts 66 and 68 of the housing relative to each other sufficiently to complete an electrical connection between the button cells and the IC. The circuit is preferably configured to continually energize the LED or to provide continual flashing thereof. The necklace of this embodiment includes a simple mechanical clasp 70 such as a snap-fit clasp and has relatively greater weight distribution toward the front of the necklace than the embodiment of FIGS. 1 and 2.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. For example, it is also contemplated that fluorescein dye may be mixed with ink to be applied to a surface of the pendant to form a logo or other indicia desired to be illuminated.

We claim:

1. A necklace having an illuminated pendant, comprising:
a pendant having fluorescent pigment;
an ultraviolet light-emitting diode proximate an edge of the pendant to illuminate the fluorescent pigment;
an electrical power source; and
means for controlling the flow of electrical current between said power source and light-emitting diode.

2. The necklace of claim 1, wherein the pendant is translucent or transparent.

3. The necklace of claim 2, further comprising a housing proximate the pendant, said housing containing said light-emitting diode, said power source and said means for controlling the flow of electrical current.

4. The necklace of claim 3, wherein the fluorescent pigment of the pendant emits visible light in response to being illuminated by ultraviolet light from the light-emitting diode.

5. The necklace of claim 4, wherein the ultraviolet light-emitting diode emits light having a peak wavelength in the range of about 390 nm to about 410 nm.

6. The necklace of claim 1, wherein the ultraviolet light-emitting diode emits light having a peak wavelength of about 400 nm.
